(19) United States
(12) Patent Application Publication
(10) Pub. No.: US 2021/0176970 A1
(43) Pub. Date: Jun. 17, 2021

(54) Smart Pet Feeding System

(71) Applicant: ChompAI Inc., Healdsburg, CA (US)

(72) Inventors: Erik Engstrom, Healdsburg, CA (US); Daniel Wheeler, Windsor, CA (US)

(21) Appl. No.: 17/247,508

(22) Filed: Dec. 14, 2020

Related U.S. Application Data
(60) Provisional application No. 62/947,355, filed on Dec. 12, 2019.

(51) Int. Cl. A01K 29/00; A01K 5/01; A01K 7/00; G05B 13/02

(52) U.S. Cl. CPC A01K 29/005; G05B 13/0265; A01K 7/00; A01K 5/01

(57) ABSTRACT

An animal feeding system having a plurality of network connectable feeding stations, each with a base with a weight sensor for measuring a quantity of animal food placed in a food container, a processor, and network connection circuitry for connecting to a computer network. A server having a processor is coupled to a database to store pet information and use AI to analyze food and water consumption and recommend new foods or issue health alerts based on the consumption data. The server is configured for communication to feeding system bases and network connectable devices, such as smart phones, having executable food management software, wherein animal food intake information is transmitted to the server; and executable artificial intelligence loaded into and running on the server receives and processes data from the feeding stations and analyzes the data to make predictions and recommendations for foods individual animals prefer.

### CROSS REFERENCES TO RELATED APPLICATIONS

The present application claims the benefit of the filing date of U.S. Provisional Patent Application, filed Dec. 12, 2019 (Dec. 12, 2019), which provisional application is incorporated in its entirety by reference herein.

### STATEMENT REGARDING FEDERALLY SPONSORED RESEARCH OR DEVELOPMENT

Not applicable.

### THE NAMES OR PARTIES TO A JOINT RESEARCH AGREEMENT

Not applicable.

### INCORPORATION BY REFERENCE OF MATERIAL SUBMITTED ON A COMPACT DISC

Not applicable.

### SEQUENCE LISTING

Not applicable.

### BACKGROUND OF THE INVENTION

### Field of the Invention

The present invention relates generally to animal feeding systems, and more particularly to a smart pet bowl system, and still more particularly to a smart pet bowl that obtains and transmits data to evaluate and monitor a pet's food preferences. Combined with data the feeding behavior of other pets, as well as other pet profile and health information, food recommendations can be generated, offered to pet owners, and automatically ordered on behalf of the pet owners.

### Background Discussion

Despite vast differences in the way pet owners relate to their pets—from those preferring to dominate and control their pets to those preferring unstructured and (arguably) more natural relationships—most earnest owners, when asked, will admit that they truly wish their animal to enjoy its meals.

Presently, most owners make food choices based on the persuasiveness of pet food packaging and advertising, both of which are littered with misleading information. Factored into the owner's choice is typically a combination of information relating to the animal's age, activity levels, breed, weight, reproductive history, and perhaps some indications relating to food allergies. Brands vary widely in the content of their foods, but at a minimum, owners are concerned to provide a pet nutritionally adequate food. The correlation, however, between nutritional adequacy and the desirability of that food for a pet is hardly established.

In an ideal world, our pets would simply tell us what they want. Unfortunately, despite the thousands of years of symbiotic relationships, animals simply cannot unambiguously communicate food preferences. They might devour food ravenously in one feeding and ignore the same food at the next. The pet food industry therefore markets pet foods to people, not to animals. Simply put, in the matter of its food, a pet has no meaningful voice.

At a pet food store, a pet owner attempting to identify his or her pet's preferences may buy a sample of foods to try, or he or she may simply seek advice from purported experts in the matter, asking store personnel or perhaps even seeking a recommendation from a veterinarian. Then, through trial and error over numerous feedings, owners will make their best judgments and inferences based on observed pet responses. An unusually curious and caring owner might perform experiments and document results, but few do because of the substantial time and patience required, and because pet conduct is rarely so reliable that uncertainty is simply inevitable. Unless a pet conspicuously avoids a particular food or readily devours it, it is difficult to know what its preference is to that particular food. Our dogs just don't tell us what they want. Furthermore, absent training and an unusual curiosity benevolently directed to a pet, people simply aren't very good at setting up and conducting such experiments or at evaluating the data obtained, nor are they interested in even undertaking the effort. The net result is that animals are provided with commercial pet food products and they typically continue to eat the same commercial food or foods for long periods of time: a change to new foods is slow. Thus, rarely do pets have any meaningful variety in their daily or weekly meal cycles.

As earlier suggested, this does not mean that owners do not care about their pets' tastes, but that they are dubious of their ability to identify them. In consequence, owners tend to focus more directly on foods that promote pet health, which is much easier to determine than feeding preferences. Indeed, that determination is largely made by the pet food industry, and owners have the luxury of deferring to these interested experts. But do pets really like those foods?

To take a small sample of trending technology in this field, an exemplary improvement in pet feeding systems is described in U.S. Pat. No. 10,091,972, to Jensen et al, which is directed to an animal health evaluation system, apparatus and method for measuring, managing and guiding the optimal amounts of the food and water consumption of one or more pets. The system registers changes in eating and drinking habits and purports to provide indications that something may be wrong with the pet, as well as dynamically addresses changes in a pet's nutrition, dietary and hydration requirements over time based on age, activity level, breed, sex, and need to lose weight. In sum and substance it's a system to provide alerts for caretakers indicating whether a dog has been fed on a predetermined schedule. It makes no use of artificial intelligence or other statistical learning for automatically generating food recommendations or evaluating and inferring health issues from feeding behavior.

U.S. Pat. Appl. No. 20100263596 by Schumann, describes a controlled food release pet feeder to aid individual weight management of a pet. The pet feeder includes an automatic computerized weight and food release mechanism. Individual pet information such as current weight, aimed for weight, and pet information is entered via pin pad instructions, and the feeder calculates exact amount of food. At each feeding the pet steps on a weight scale, which automatically updates the pet's weight information and recalculates food output. A veterinarian must be consulted to determine the pet's healthy weight and regular check-ups with the pet's veterinarian are required during the weight loss program.

U.S. Pat. Appl. Ser. No. 20190029221, by Anderton, teaches a system for recommending and providing food to an animal which includes a computer and server system used with a feeder and a collar. The computer system receives animal food consumption data, activity data, profile data, environmental data. The server includes an animal feed database and uses the input data to compare animal profile data to the profile database to determine baseline consumption for a given animal, and then compares food consumption information or activity information with the animal feed database to determine a type and quantity of food to be fed to the animal. The system does not in any way consider animal preferences.

The foregoing patents reflect the current state of the art of which the present inventors are aware. Reference to, and discussion of, these patents is intended to aid in discharging Applicants' acknowledged duty of candor in disclosing information that may be relevant to the examination of claims to the present invention. However, it is respectfully submitted that none of the above-indicated patents disclose, teach, suggest, show, or otherwise render obvious, either singly or when considered in combination, the invention described and claimed herein.

### BRIEF SUMMARY OF THE INVENTION

The inventive smart pet feeding system of the present invention gives to pets a voice for expressing food preferences. Caretakers and pet food manufacturers will be influenced to market to pet preferences rather than to values and concerns imposed on pets by pet owners.

The invention uses network connectable food weight scales and one or more cloud-based servers running AI software to measure and process data relating to animal feeding behavior, and based on the computed data to predict the preferences of particular pets for certain foods, and then to transmit the preference information to the animal owners and optionally to pet food stores and veterinarians. In the simplest terms, it helps pet owners and other caretakers identify the foods pets prefer based on the rapidity with which the pets eat those foods. The system also automatically explores and recommends other foods an animal is likely to enjoy, and it recommends gradually changing foods in accordance with the aging of an animal. It responds to owner's food preferences or health concerns, and notifies owners and veterinarians of potential health concerns. It can track a food inventory and automatically order more of an owner-specified food, or allow the pet to determine the food to be ordered based on observed preferences and the owner's budget and food requirements.

The invention consists of a feeding station which has a base with processing, memory, a weight scale, a camera, a speaker, and wireless communication capabilities. A food container is placed on the base and food may be placed in the container. Load cells or other kinds of weight sensors detect and measure the weight of the food placed in the food container. Data relating to the weight and time the food is placed, and then relating to the time it takes an animal to eat the food is collected. Instead of using the base and food container as the primary hardware components for evaluating pet food preferences, a camera can be used to monitor animal behavior at the food dish.

A user portal on a network connected mobile device or a personal computer is employed to transmit and receive information from a server in the cloud. The server collects animal feeding information, analyzes the data, recommends new foods, handles food ordering, and executes other functions required to automate the identification, ordering, and evaluation of pet food.

In embodiments, the system includes a camera incorporated into the base to assign food consumption to a particular animal. The same camera can be used to scan food packaging (for instance, bar codes or product names) to determine the product being fed to the pet. The same function can be performed using the mobile device.

A speaker provides an audible output when pet food is scanned to provide feedback to the user—for instance an audible confirmation of the product name. The speaker can be configured to output unpleasant (minimally, irritating) sound to repel unrecognized/unauthorized animals from eating from the dish.

In embodiments, the feeding system evaluates an animal's preference for a particular food. This is accomplished by weighing the food dispensed into the food bowl, then measuring the weight of the food during consumption. The consumption profile is then analyzed to determine an animal's preference. For instance, the rate at which the food is consumed is measured and analyzed, as it is well known that when a dog eats especially slowly, it's a sign that it does not like its food.

In other embodiments, the animal's food preference is analyzed principally by observing and recording animal behavior using a camera in combination with AI analytics and/or human evaluation of the live eating session, or of video recordings.

When subscribing or otherwise joining the feeding system network, the pet owner can input information relating to food requirements, pet health issues, and even information about the pet's peculiar characteristics. Both initially and over time as feeding data is collected, the animal's preferences, food requirements, and new foods can be selected, recommended, and ordered with or without human interaction. From the vast volume, velocity, and variety of data maintained relating to pet feeding behavior and potentially related health information, the system AI can also determine potential health issues evidenced by the feeding behavior.

Recommendations can be shaped according to user preferences as well. For instance, the pet owner/caretaker can set a budget to ensure that recommended foods are optimized for enjoyment within the budget. As a pet ages, its taste preferences change and health issues may arise, each affecting what and how the system recommends new foods.

In embodiments, one or more cameras are included at or in the feeding station to ensure proper animal recognition. In households where more than one animal is present and more than one are allowed to feed from the same feeding station, some method must be employed to distinguish the animals from one another so as not to have a confused data set. Alternatives to visual identification include, for instance, RFID collars, ear chip or subdermal chip, or similar identification schemes. In embodiments, the feeding station may include a scale coupled to the feeding station base and on which the animal must stand to access the food bowl, and weight itself may be employed to identify the animal feeding.

Embodiments may include speakers for providing audible feedback to a user that a food identified or entered into the system has been recognized and accepted.

In preferred embodiments, the system is implemented through a cloud-based architecture include remote data storage and analysis in a cloud-based server running AI that recommends and transmits food recommendations. However, it is contemplated, and within the scope of the invention, that future iterations of AI may permit local AI implementation in either the feeding station or the user interface hardware and software. The AI may be able to recruit the connected device to call, fax, or otherwise transmit a food order without using the internet.

AI promotes the present invention beyond that of a mere data logging system to a food evaluation and recommendation system. In embodiments, the AI may be employed to generate food purchase orders automatically.

The critical information required for evaluating feeding preferences and health implications is animal identification, food weight, and feeding behavior, principally the time it takes to consume the food placed in the food bowl. The information collectively cooperates to provide the telemetry needed for determining preferences and health implications.

While system software, including AI, may reside only in the user interface hardware or in the feeding station, there would be a resulting reduction in learning from animal and owner peers. Thus, the cloud architecture is an advantageous model. However, local data transfer to the user interface via wireless or wired data connection may include routing that does not include the internet. If AI were to reside in the feeding station or UI hardware, the AI could download data from the cloud or from peer feeding stations.

From the foregoing, it will be seen that the inventive smart pet feeding system includes three components: a feeding station (FS), a user interface (UI), and AI implemented in the cloud.

In embodiments, the system is preferably implementation as FS+UI+AI. However, other combinations include:

(FS+UI)+AI, one piece of hardware plus cloud computing;

(FS+AI)+UI, two pieces of hardware, configured with AI in the feeding station;

(FS+AI+UI), all one unit; and

FS+(UI+AI), two pieces of hardware, configured with AI in the UI hardware.

The foregoing summary broadly sets out the more important features of the present invention so that the detailed description that follows may be better understood, and so that the present contributions to the art may be better appreciated. There are additional features of the invention that will be described in the detailed description of the preferred embodiments of the invention which will form the subject matter of the claims appended hereto.

Accordingly, before explaining the preferred embodiment of the disclosure in detail, it is to be understood that the disclosure is not limited in its application to the details of the construction and the arrangements set forth in the following description or illustrated in the drawings. The inventive apparatus described herein is capable of other embodiments and of being practiced and carried out in various ways.

Also, it is to be understood that the terminology and phraseology employed herein are for descriptive purposes only, and not limitation. Where specific dimensional and material specifications have been included or omitted from the specification or the claims, or both, it is to be understood that the same are not to be incorporated into the appended claims.

As such, those skilled in the art will appreciate that the conception, upon which this disclosure is based may readily be used as a basis for designing other structures, methods, and systems for carrying out the several purposes of the present invention. It is important, therefore, that the claims are regarded as including such equivalent constructions as far as they do not depart from the spirit and scope of the present invention. Rather, the fundamental aspects of the invention, along with the various features and structures that characterize the invention, are pointed out with particularity in the claims annexed to and forming a part of this disclosure. For a better understanding of the present invention, its advantages and the specific objects and advantages achieved by its uses, reference should be made to the accompanying drawings and descriptive matter in which there are illustrated the preferred embodiments.

### BRIEF DESCRIPTION OF SEVERAL VIEWS OF THE DRAWINGS

FIG. 1 is a schematic view of an embodiment of system architecture and topology;

FIG. 2 is a high level flow diagram for an embodiment of the inventive application through which animal/pet owners or caretakers monitor pet health and identify pet feeding preferences;

FIG. 3 is a flow chart showing how artificial intelligence may be employed in the present invention to recommend food choices and prospective purchases based on animal feeding behavior analyzed in relation to a large data set of information from a plurality of pet owners;

FIG. 4 is a flow chart showing information acquisition and processing for the feeding station employed in embodiments of the present invention;

FIG. 5 is a schematic view showing the feeding station structures and operations, as well as wired and wireless configurations for pushing data from the feeding station to a cloud server having a database for storing and processing data relating to animal feeding behavior;

FIG. 6 is schematic view showing a network connectable device showing a display interface in a social network related to the inventive system;

FIG. 7 is a schematic view showing another display interface in the social networking system;

FIG. 8 is a schematic view showing a display interface with emergency alerts, warnings, and information that may be sent to the user's device by the system server;

FIG. 9 is a schematic view showing a display interface featuring a proposed pet food order that includes recommended varieties and their respective costs and “likeability” scores;

FIG. 10 is a schematic view of a display interface showing how a pet owner inputs information concerning the food inventory in connection with which animal feeding behavior will be monitored;

FIG. 11 is a schematic view showing an embodiment of a display interface that might be presented to the pet owner after completing entry of the food inventory as shown in FIG. 10;

FIG. 12 is a schematic view showing an embodiment of a display interface for entering animal data; and

FIG. 13 is a schematic view showing a display interface enabling a user to locate nearby pet feeding stations.

### DETAILED DESCRIPTION OF THE INVENTION

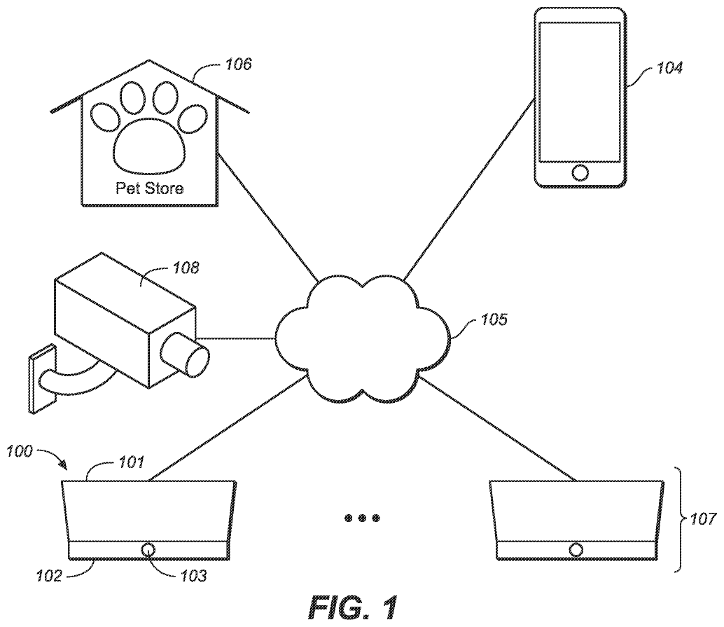

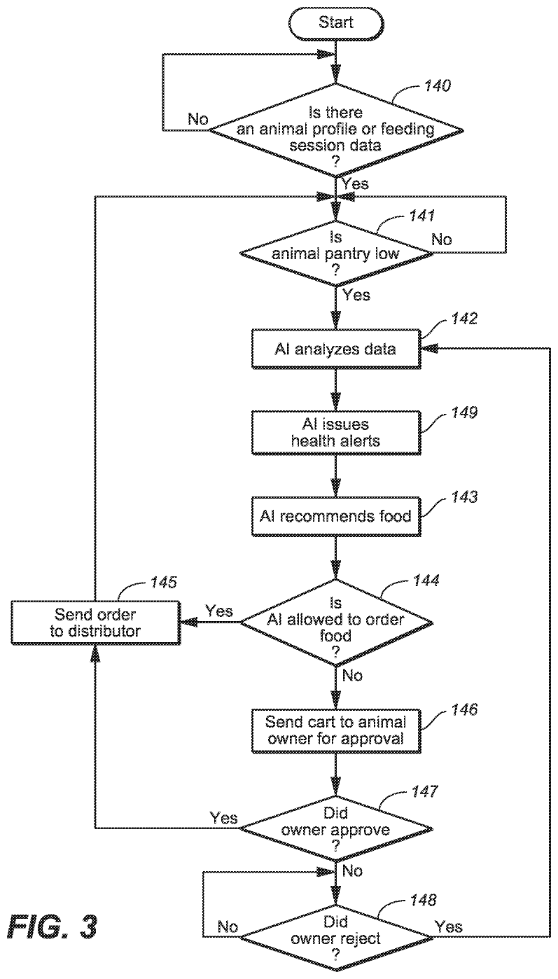

Referring to FIGS. 1 through 13, wherein like reference numerals refer to like components in the various views, there is illustrated therein a new and improved smart pet feeding system, generally denominated 100 herein.

Referring first to FIG. 1, there is shown a schematic view of the architecture of an embodiment of the smart pet feeding system of the present invention. As will be readily apparent to one having skill in the art, the system exploits now ubiquitous wireless telephony, big data, cloud computing, and IoT technologies, with architecture structured accordingly. Thus, in an embodiment, the inventive smart pet feeding system includes hardware components 100 that are wirelessly linked over a network, typically the Internet, to a cloud based server 105.

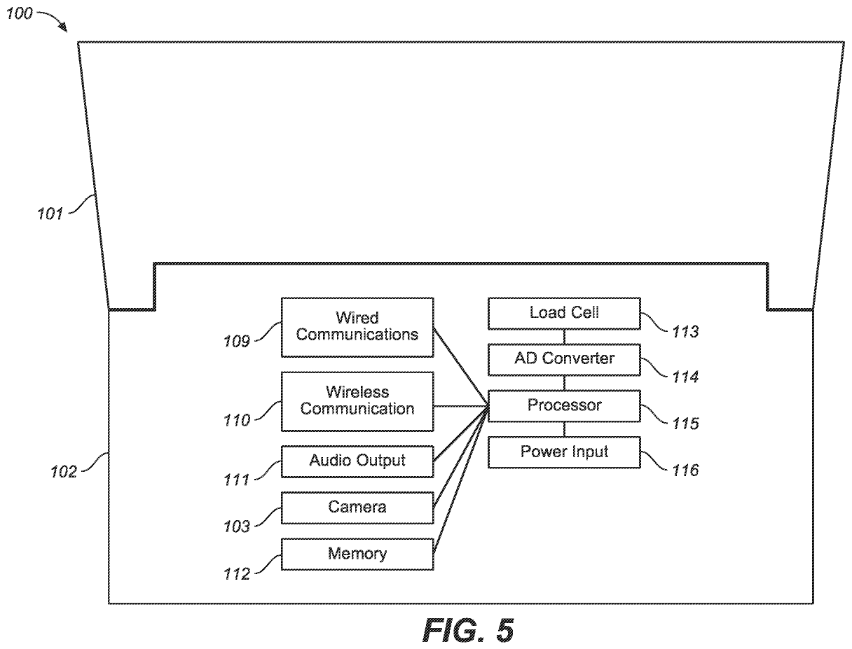

The system also includes a plurality 107 of feeding stations, each of which, in their most essential form, include a removable food bowl or container 101 disposed atop a weight scale base 102 having one or more weight sensors or load cells to detect and weigh food placed in the bowl. Any of a number of force detectors and motion sensors could be employed to detect food in the food container and an animal's engagement with the food container, including the above-mentioned load cells. A camera 103 for detecting the presence and providing an image to identify an animal is incorporated into or coupled to the base and configured to capture images of a feeding animal. More details on the base features and functions are shown in FIG. 5.

As may be understood from the illustrations, system architecture includes components for an IoT-type system; thus, the cloud-based server includes a database that stores, processes, and provides access to the history and current data of all feeding systems included in the feeding system network. The cloud-based server runs AI software and provides high volume data storage and application processing capabilities that enable the system to process and analyze data continuously and historically generated from pet owners and feeding systems connected to the network.

The system is designed for easy use with any of a number of network connectable devices in use at the moment, viz., and most commonly, smart phones (mobile phones with memory, a processor, and a graphical user interface). However, the connected can include wearable smart watches, tablets, desktop computers, laptops, and so forth.

The feeding station preferably includes a second camera 108 for comprehensive data capture of the image and behavior of a feeding animal. When an animal feeds at the food container, the camera is activated with a proximity sensor or other sensor and sends image data to the cloud based server 105, which has image recognition software to compare and reconcile such data with previously provided image data for one or more subject animals under the care of an owner. Additionally, the behavior characteristics captured by the camera—e.g., eagerness, enthusiasm, and rapidity in eating. Thus, the second camera offers another way to evaluate pet food preferences.

In embodiments, a feeding station app may be downloaded from the cloud-based server to both the network connectable device and to the feeding station base. The system and its method are then implemented using a combination of software and hardware, with some human intervention.

By its nature, the system necessarily includes a large number of network connectable smart devices 104, each having a user interface for selectively sending and receiving transmissions over the network to the cloud based server 105. The system is intended for use with an effectively unlimited number of animal owners and caretakers. The more data stored and available for computation, the more reliable the output information in the form of feeding recommendations to users.

Finally, in its most essential aspect, the system includes connections to a large number of pet food stores 106. How the feeding station and its cameras, the smart devices, and stores exchange information is discussed more fully below.

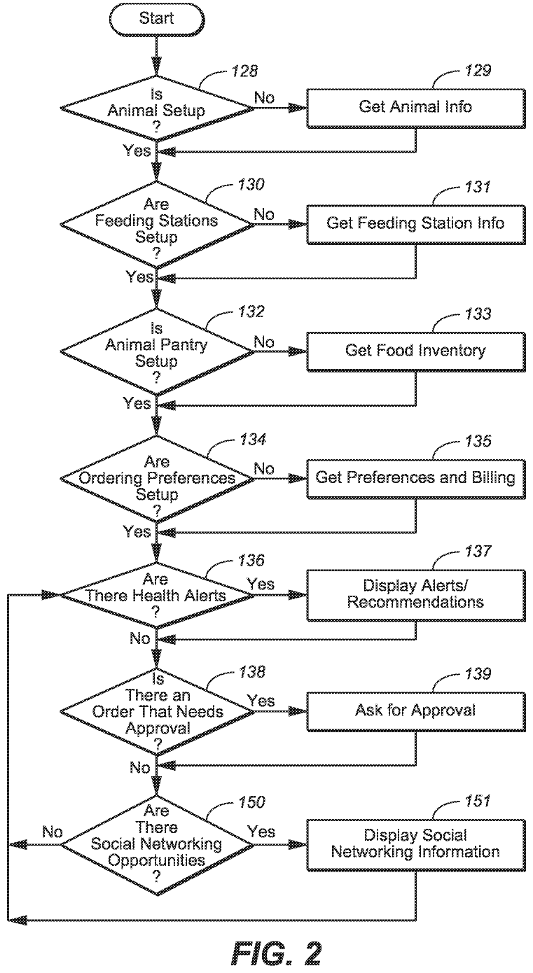

Referring next to FIG. 2, use of the system begins with acquiring and providing the above-described feeding system hardware components. Then, the mobile app for the system is located on the internet and downloaded using the network connectable device (hereinafter mobile device, for convenience only, and without limiting the actual kind of device employed) using the user interface. In embodiments, the mobile device could be a mobile device running any of the currently common operating systems, such as Apple iOS, Android, Blackberry, Microsoft, Amazon, etc. The app may be offered by an app store or otherwise available online, as monetization of the system is in no respects tied to the sale of the app itself. Basic and versions with additional custom features are considered with the scope of the invention. Ongoing access using either a data plan tied to a mobile device service or via wifi are each contemplated. Likewise, security and use restrictions may be implemented, as well known in the art, but such issues are not considered herein as being non-essential to the invention.

Once downloaded, after starting the app the user will initially be questioned 128 about whether an animal's information is set up. On prompting, information for animals new to the system is input 129 using the user interface. There is no limit to the kind of information that may be relevant to the system purposes, but essential information will include the kind of animal, breed, age, weight, sex, health history. Possibly useful collateral information may include veterinarian information, owner information, breeding method that produced the animal, if known (e.g., line breeding, inbreeding, outcrossing, etc.), and the like.

Once the animal information is entered, the UI queries whether a feeding station or stations are set up 130. If not, feeding station information is entered 131 and set up for use over a network. This may include detecting and completing a feeding station base connection to the internet and determining that the food container is correctly detected. If the feeding station is newly commissioned, the system will lead the user through testing with a diagnostic food sample.

If the user has not yet input data relating to the animal pantry (i.e., pet foods identified by brand and labels, possibly including SKUs and other information sufficient to determine nutritional adequacy and flavors), 132, the program (app) next prompts the user to input that information 133. The user may also include information relating to food variety, lot number, “best buy” dates, ingredient sources, manufacturer claims relating to FDA verifiable food grade, nutritional adequacy and feed trial proof, customer support information, manufacturing location, any applicable recalls, ingredient quality claims, and certifications of compliance with health and production regulations.

The program then determines whether ordering preferences have been set up 134, and if not, it presents the user with a query seeking food order preferences 135. Such preferences may include a threshold food quality and any other dietary restrictions that may apply (e.g., food allergies), a list of preferred food retailer accounts, billing information and payment sources, spending limits per defined time period (e.g., monthly), whether the AI is permitted to exercise discretion and/or to order food as a proxy for the owner.

The program then determines whether there are any health alerts to be displayed 136, and if so passes control to an alert generator that displays health alerts and recommendations via the visual display 137. If not, or after displaying alerts, the program then determines whether there is an outstanding order in need of user/owner approval 138. If so, the program prompts the user through the UI for approval 139; if not, the program looks to see whether at that time there are any social networking opportunities 150. For instance, the program will look to see whether there are any users logged in and having a similar animal about which information may be shared. If yes, then the social networking information is displayed and users may be connected 151. Exchanges may include information from users relating to foods that they have found to be superior to foods recommended by the system AI, as well as hedonic scores for similar animals and foods that they are eating. Once the social networking information has been displayed, control passes back to block 136 for a check of whether health alerts are present.

If on starting the app an animal profile is absent 140, control passes to the processing steps set out above. If a profile is available and/or feeding session data is available, the system will calculate and evaluate whether the animal pantry is low of food based on the amount consumed as a percentage of the amount entered for the product package and provides an indication if an order is needed 142. The system AI analyzes feeding session data 142, issues any needed health alerts, FDA bulletins, or veterinarian notifications 149, recommends and displays on the UI any foods identified as fitting the animal's preferences 143, and determines whether AI is allowed to order food without owner approval or input 144. If AI is authorized to order food, it will transmit an order to a distributor 145 identified at step 135, above.

If AI is not authorized to send orders independently, it will seek and receive either an approval or an express refusal of the order from the owner. The product shopping cart is then sent to the owner for approval 146. If the order is approved 147, the order will be placed via that UI; if not, the negative outcome is fed back to the decision step of whether an approval is obtained and the subroutines repeat.

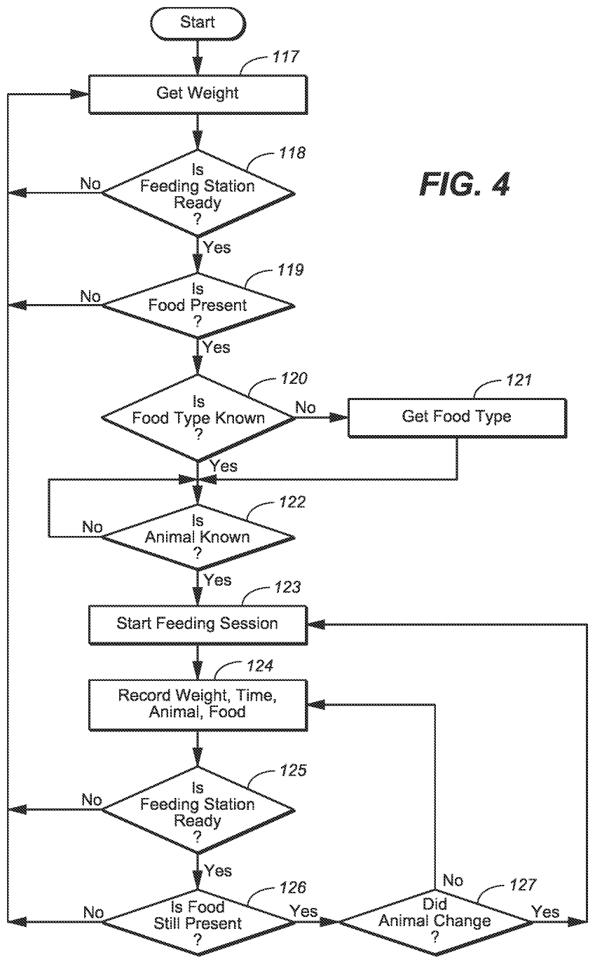

To obtain and process data from a feeding session, shown in FIG. 4, the weight of the food container must first be obtained 117. When the food container is present, the system begins when an owner places food into the feeding station food container. The base detects the weight and records the weight data and determines whether the feeding station is ready for use 118. If not, then the system remains poised to obtain food container weight information. If so, then it looks to see whether food has been placed in the food container 119. It does so simply by detecting a difference in weight.

When food is placed in the food container, the system looks to see whether the food type is known 120. If not, the UI prompts the user at 121 to input food type information of the kind set out above. When the food type is known, the system queries whether the animal is known at 122. If not, the negative outcome is fed back into the query until the animal is recognized using means implemented in the feeding station either using a singular device, such as a camera, or with cooperative devices, such as an RFID collar communicating with the feeding station, or any other known means for restricting the animal feeding from the dish and for preventing inaccurate feeding data being transmitted to system logic and data processing.

When the animal at the station is identified and the feed type determined, the system begins collecting data for the feeding session 123. Data relating to the weight of the food, the feeding time, and animal, and the food eaten are all recorded 124.

After a feeding session has concluded, the system again looks to see whether the feeding station is ready, and for systems with removable food containers, the program determines whether the food container is present and placed on the base 125. If the outcome is negative, the system loops back 117 to obtain the weight of food placed in the food container. If the system is ready, the system looks to see whether food is still present from an ongoing feeding session 126, and whether a feeding animal is the same animal that began the (possibly interrupted or ongoing) feeding session, and if the outcome is positive, the system loops back to block 123 to execute the same subroutines in order for the new animal; if the outcome is negative (i.e., the same animal is still feeding or has returned to feeding), the program loops back to box 124, where the subroutines are again executed in order.

Referring next to FIG. 5, there is shown a schematic view of possible circuits and devices incorporated in a feeding system base 102, as well as wired and wireless configurations, for obtaining data from an animal feeding from the food container 101 of the feeding station 100 and transmitting the data to a cloud server having a database for storing and processing data relating to animal feeding behavior. This view shows that in embodiments the means for transmitting data to the cloud-based server may be wired 109 or wireless 110. The base may further include an audio output or speaker 111 for confirming scanned food product and for emitting sounds to deter unwanted animals from feeding from the food container.

The base provides a physical enclosure for various electronic components, including memory 112 coupled to processor 115, a load cell 113 for detecting and measuring the weight of the food container and the weight of food placed in the food container, an analog/digital converter 114 for converting the signal output from load cell 113 from an analog to digital signal, and a camera 103. Power 116 may be provided by batteries or through a power cord connected to a nearby electrical outlet.

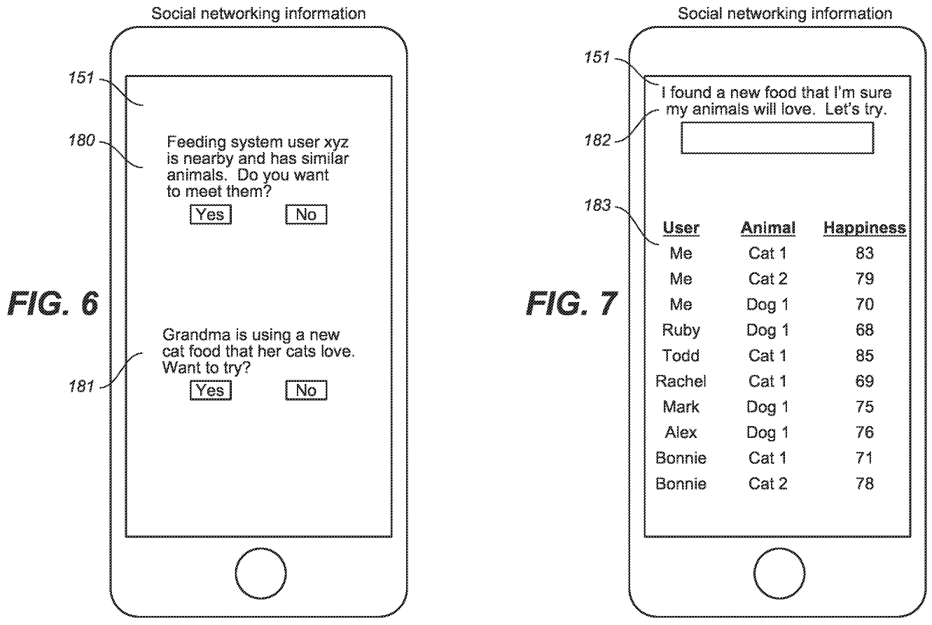

FIGS. 6-7 provide examples of how the visual display 151 of the connected device 104 user interface might appear when the system determines that there are nearby users of the system who have similar animals 180. The user can provide information to persons in the user's social network about food changes found to be successful, inviting them to try that food. In fact, and looking now at FIG. 7, users can compete against system AI in identifying which foods animals will like best 182, which is a gamification of information sharing on social networks. The result of such a challenge will elicit a scoreboard displaying users with high hedonic scores relating to the proffered food.

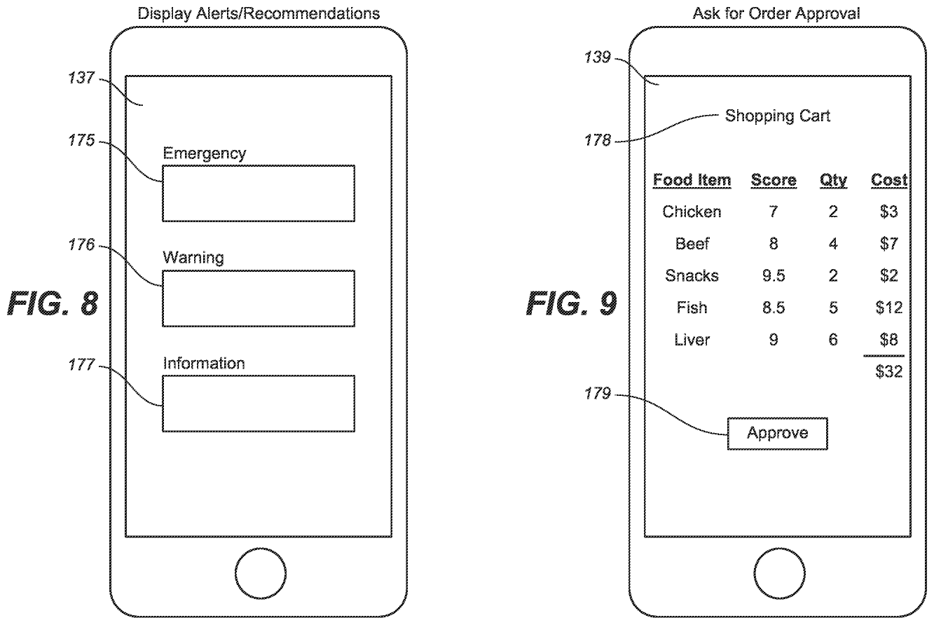

FIG. 8 shows embodiments of a UI when presenting a user with health alerts and recommendations 137. The display may rank the notices from most important, i.e., emergencies 175, through warnings 176, to information 177. The emergencies notifications may include such things as pet food recalls, air quality alerts, significant departures from feeding schedules, and so forth. Warnings may include non-urgent important information for which action may be deferred or declined, such as information about foods demonstrated to promote health and longevity, facts relating to an animal's departure from normal eating patterns, and indication that the animal's veterinarian has been notified, and so forth. Merely useful information may also be displayed 177, and it may include such things as an announcement of a newly introduced pet food, new facilities for animals (e.g., new nearby dog parks), information about products shown to be beneficial or detrimental animal health.

FIG. 9 shows a shopping cart 178 on an order approval page 139 in the UI. The information is pushed to the user by system AI, and in embodiments it may include the recommended food item, it's predicted score for “likeability”, the quantity recommended for the panty, and the cost. If the user approves the recommendation, he/she can select Approve 179.

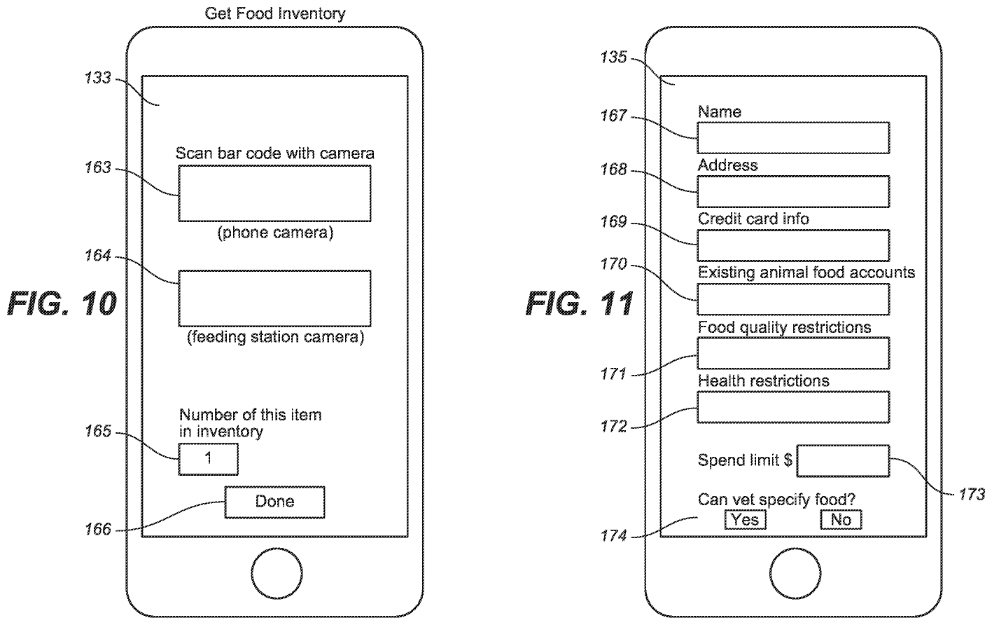

Looking next at FIG. 10, there is shown a schematic view of a UI 133 for inputting information concerning the food inventory in an animal's food pantry. In embodiments, the camera in the mobile device is employed to scan the bar code of a pet food package 163. In the alternative, the bar code may be scanned 164 by the camera in the feeding station base. The user then specifies the quantity of the particular food item in an animal's pantry 165. When this food identification process is complete, the user touches the appropriate indicator bar 166.

FIG. 11 is a schematic view showing the display interface 135 that may be presented to the pet owner after completing entry of the food inventory as shown in FIG. 10. This UI is structured to allow a user to purchase a pet food using a payment card and thus includes windows for entering user identification and contact information 167/168, credit card information 169, existing pet food retailers and accounts used by the user 170, as well as any food quality restrictions 171, health restrictions 172, and spending limits 173 that may have a bearing on the purchase. This display also permits the user to indicate whether the user's vet is authorized to recommend and/or specify food purchases for the animal 174.

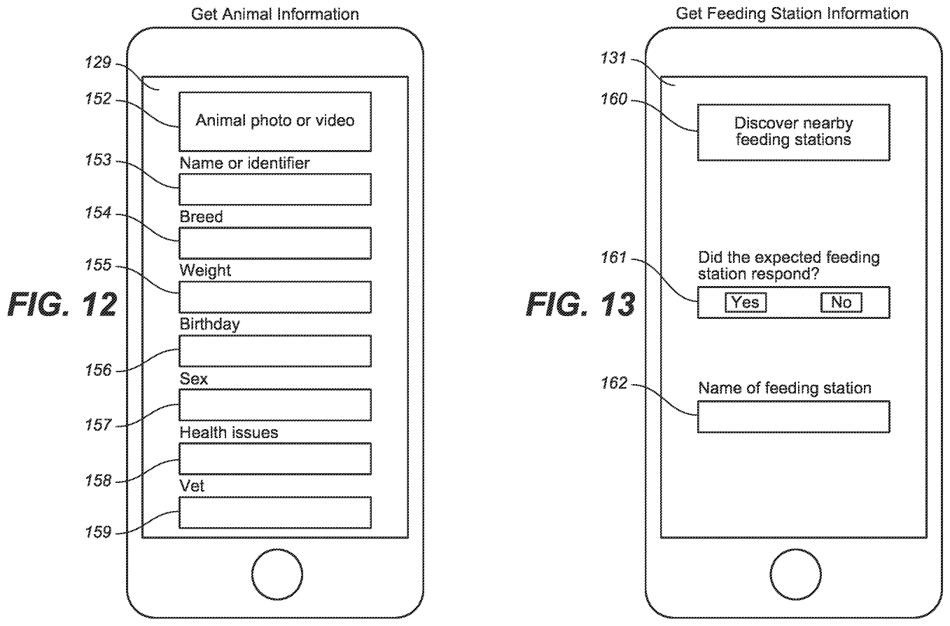

FIG. 12 shows the mobile device display for entering animal data 129. The data for input includes an animal photo 152, preferably having sufficient detail and clarity for use in image correlation for biometric identification, an animal name or identifier 153, animal breed 154, weight 155, birth date 156, sex 157, health issues 158, and the name and contact information for the animal's veterinarian 159.

FIG. 13 shows a display interface enabling a user to locate nearby pet feeding stations 131. To instruct the system to carry out this task, the user transmits the command via touch at 160. The system then prompts the user to indicate whether the feeding station responded 161 and to specify the name of the feeding station 162.

In embodiments, the AI used in the system collects, collates, organizes, and processes data points from potentially tens of millions of system users. Predictions of preferred foods are then made using any of a number of AI approaches, including machine learning algorithms, convolutional neural networks, and deep neural nets. The factors for determining food preference include, but are not limited to, speed of consumption, how much was consumed in relation to how much the animal has eaten recently, how quickly the animal starts eating after the food is placed, whether the animal starts eating as soon as the dish is approached, or waits, and whether the animal fully finishes the meal or just eats until no longer hungry.

The above disclosure is sufficient to enable one of ordinary skill in the art to practice the invention, and provides the best mode of practicing the invention presently contemplated by the inventor. While there is provided herein a full and complete disclosure of the preferred embodiments of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like.

Therefore, the above description and illustrations should not be construed as limiting the scope of the invention, which is defined by the appended claims.

What is claimed as invention is:

1. An animal food preference and health evaluation system, comprising:
a plurality of feeding stations, each of said feeding stations having a base, a food bowl disposed atop said base, a weight sensor for measuring a quantity of animal food in said food bowl, a processor, and network connection circuitry for connecting each feeding station to a computer network;
a server having a processor coupled to a database for storing pet information and using artificial intelligence for analyzing data relating to food and water consumption received from said feeding stations and recommending new foods or issuing health alerts, or both, based on data relating to a particular animal's profile and food and or water consumption, said server configured for bidirectional communication over a network with a plurality of feeding station bases and network connectable devices, said network connectable devices having a processor, memory, a radio frequency transmitter, a visual display and a user interface, and executable animal food management software, wherein animal food intake information is transmitted to said server; and
executable artificial intelligence loaded into and running on said server for receiving and processing data transmitted from said plurality of feeding stations relating to the feeding behavior of identified animals eating identified pet foods and for analyzing the data to make predictions and recommendations for foods individual animals show a preference for or are likely to promote the animal's health.

2. The animal food preference and health evaluation system of claim 1, further comprising a camera for identifying individual animals, wherein food and/or water consumption may be assigned to an individual animal associated with a particular feeding station.

3. The animal food preference and health evaluation system of claim 1, further including a camera for identifying the manufacturer and brand of the pet food placed in said food bowl at one of said plurality of feeding stations.

4. The animal food preference and health evaluation system of claim 1, wherein a plurality of said feeding stations include multiple food dishes and water dishes, and wherein said feeding stations are configured to detect and identify each dish or each animal associated with a particular feeding station.

5. The animal food preference and health evaluation system of claim 1, wherein said food management software is configured to enable a user to specify the food being dispensed to a particular food bowl and feeding system using said food management software, and wherein information relating to the food placed in said food bowl can be entered either by scanning a barcode, by image recognition of food packaging, and by manual entry of the manufacturer and other brand identifying information.

6. The animal food preference and health evaluation system of claim 1, wherein said system is configured to track food inventory by one or more of direct input of inventory by a human user, tracking purchases made through inputs by a human user through said user interface, consumption of food entered at feeding time through bar code scanning, image recognition, and direct entry of consumption.

7. The animal food preference and health evaluation system of claim 6, wherein said system is configured to maintain minimum required inventory by sending recommendations for animal food purchases to users and to reorder food with or without user interaction.

8. The animal food preference and health evaluation system of claim 7, wherein said system includes artificial intelligence configured to automatically recommend and order samples of food, with or without user interaction, using an animal's food consumption history and comparing it to similar animals' food consumption histories.

9. The animal food preference and health evaluation system of claim 7, wherein said system is configured to recommend and order food within a predetermined price range, with or without user interaction, and thereby to maximize an animal's preferred food or most health promoting food.

10. The animal food preference and health evaluation system of claim 8, wherein said system is configured to recommend and order only foods having certain qualities, with or without user interaction, based on user input made through said user interface.

11. The animal food preference and health evaluation system of claim 7, wherein only foods that address certain animal health issues are recommended and ordered, with or without user interaction, based on input made by the user through the user interface

12. The animal food preference and health evaluation system of claim 7, wherein said system is configured to provide animal feeding data to an animal's veterinarian and wherein the veterinarian is enabled to specify the food to be ordered.

13. The animal food preference and health evaluation system of claim 1, wherein an artificial or human intelligence analyzes an animal's sustenance intake characteristics to detect probable health issues and recommends corrective action including, but not limited to, new foods, articles and knowledge databases, a veterinarian contact, and scheduling an appointment with a veterinarian.

14. The animal food preference and health evaluation system of claim 1, further including an audio speaker installed on said feeding station to provide audio feedback.

15. The animal food preference and health evaluation system of claim 3, further including a microphone for audibly inputting user feedback that an animal food has been properly detected and a speaker for audibly outputting various error conditions or statuses.

16. The animal food preference and health evaluation system of claim 15, wherein the speaker is used to detect and transduce audible animal sounds as feedback.

17. The animal food preference and health evaluation system of claim 16, wherein said speaker enables audible communication to an animal at said feeding station with either live or pre-recorded messages.

18. The animal food preference and health evaluation system of claim 16, wherein said speaker is used in conjunction with said camera to scare away animals not meant to be fed by the dish.
